(19) United States
(12) Patent Application Publication
(10) Pub. No.: US 2004/0208119 A1
(43) Pub. Date: Oct. 21, 2004

(54) Providing a node of a peer-to peer network with access to a resource

(76) Inventors: Athena Christodoulou, Bristol (GB); Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(21) Appl. No.: 10/774,121

(22) Filed: Feb. 6, 2004

(30) Foreign Application Priority Data
Apr. 15, 2003 (GB) 0308736.8

(51) Int. Cl. H04L 1/22

(52) U.S. Cl. 370/228; 370/431

(57) ABSTRACT

A method of providing a node 200 of a peer-to-peer network 250 with access to a resource 210 located within the network 250 comprising providing the node 200 with at least one link to the resource 210 which is actuable to connect the node 200 to the resource 210 and the link having associated therewith information which provides an action that the node 200 accessing the resource 210 using the link should perform if the access should fail.

The present invention relates to providing a node of a peer-to-peer network with access to a resource.

One use of Peer-to-Peer networks is file sharing and such networks are becoming increasingly familiar. Such peer-to-peer networks comprise communities of computer devices, which may be called nodes, each having knowledge of a limited number of other nodes. The files may provide a resource that other nodes may wish to obtain, however, other resources may also be desired by nodes. If file sharing is being performed a first node can request a file from the nodes of which it has knowledge and each one of those nodes can either supply the requested file or can pass on the request by querying other nodes to which they have knowledge.

In some embodiments and assuming the requested file, or other resource, is found on one of the nodes, an HTTP (Hyper Text Transfer Protocol) link is sent back to the first node using the same route as the query took from the first node to the node on which the file was located. This link allows the first node to connect directly with the node having the file, or other resource, and allows the file, or other resource to be transferred, or otherwise utilised, to or by the first node.

Information is often duplicated on various nodes and further may not be the file, or other resource, the first node intended to find. The choice of which file, or other resource, to select from many possibilities may generally be left to the user of the first node.

Therefore, locating a file or other resource on a distant node can be time consuming for the user of the first node. Indeed, just because the desired resource has been located on a distant node does not mean that that node can successfully supply that resource. The network connections to that node may be poor, that node may be undergoing a significant number of hits for that resource and therefore be overloaded, etc.

According to a first aspect of the invention there is provided a method of providing a node of a peer-to-peer network with access to a resource located within the network comprising providing the node with at least one link to the resource which is actuable to connect the node to the resource and the link having associated therewith information which provides an action that the node using the link to access the resource should perform if access to the resource should fail.

An advantage of such a method is that it may help to increase the tolerance of the peer-to-peer network to faults within the network connections, overloading of one or more nodes or the like. As such the speed that a node of the network can access a remote resource may be increased. Failure of the link may be by way of an absolute failure in which no data can be transmitted across the link, or may be by slow and/or erratic performance.

According to a second aspect of the invention there is provided a peer-to-peer network comprising a plurality of nodes each capable of communicating with one another, said nodes being arranged to provide to one another links to resources within the network actuable to connect a node to the resource, said nodes being further arranged to associate with such links information which provides an action that the node using the link should perform if access to the resource should fail.

According to a third aspect of the invention there is provided a node of a peer-to-peer network comprising a transceiver and a processing means, said transceiver being arranged to connect to the network and receive at least one link to a remote resource which is actuable to connect the node to the remote resource, the link having information associated therewith said transceiver being arranged to pass said link and information to said processing means, said processing means being arranged to attempt to access a resource provided by said link using said transceiver and further arranged to monitor said transceiver during the attempted access, and the processing means being further arranged to carry out an action provided by the information should the monitoring of the transceiver determine that access to the resource has failed.

According to a fourth aspect of the invention there is provided a machine readable medium containing instructions which when read by a computing device cause that computing device to perform the method of the first aspect of the invention.

According to a fifth aspect of the invention there is provided a machine readable medium containing instructions which when read on to at least one node of a peer-to-peer network cause the network to function as the network of the second aspect of the invention.

According to a sixth aspect of the invention there is provided a machine readable medium containing instructions which when read on to a node of a peer-to-peer network cause that node to function according to the third aspect of the invention.

According to a seventh aspect of the invention there is provided a software agent for a node of a peer-to-peer network, the software agent being arranged to process information associated with a link, provided to the node, which is actuable to connect the node to a resource and the software agent being arranged to cause the node to perform an action should the link fail to provide access the resource.

The software agent may be a plug-in, or other attachment, to an existing software agent. Such an arrangement is convenient because it may allow the software agent to be readily used. It will be appreciated that some software agents, for example a browser such as Microsoft™ IE, or Netscape™ Navigator, or the like have a large installed user base.

According to an eighth aspect of the invention there is provided a machine readable medium containing instructions which when read on to a computer cause that the software agent of the seventh aspect of the invention to be loaded onto the computer.

According to a ninth aspect of the invention there is provided a computer program which allows a node of a peer-to-peer network to receive at least one link actuable to connect the node to a remote resource on at least one other node of the network, the link having information associated therewith, the program allowing the node to attempt to access the remote resource provided by the link, and monitor progress of the attempted access, the program being further arranged to carry out an action provided by the information should monitoring of the attempted access determine that the access has failed.

The machine readable medium of any of the above aspects of the invention may be any one or more of the following: a floppy disk; a CDROM/RAM; a DVD ROM/RAM (including +RW,−RW); any form of magneto optical disk; a hard drive; a memory; a transmitted signal (including an Internet download, file transfer, or the like); a wire; or any other form of medium.

Embodiments of the invention will now be described, by way of example, and with reference to the accompanying drawings in which:

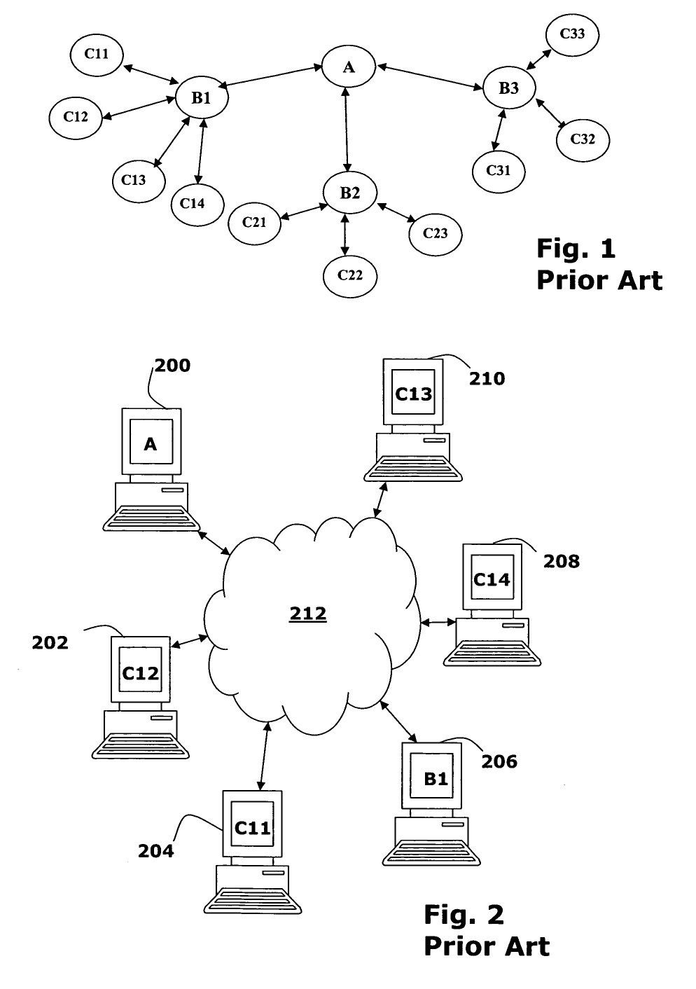

FIGS. 1 and 2 are schematic illustrations of the arrangement of example prior art Peer-to-Peer networks;

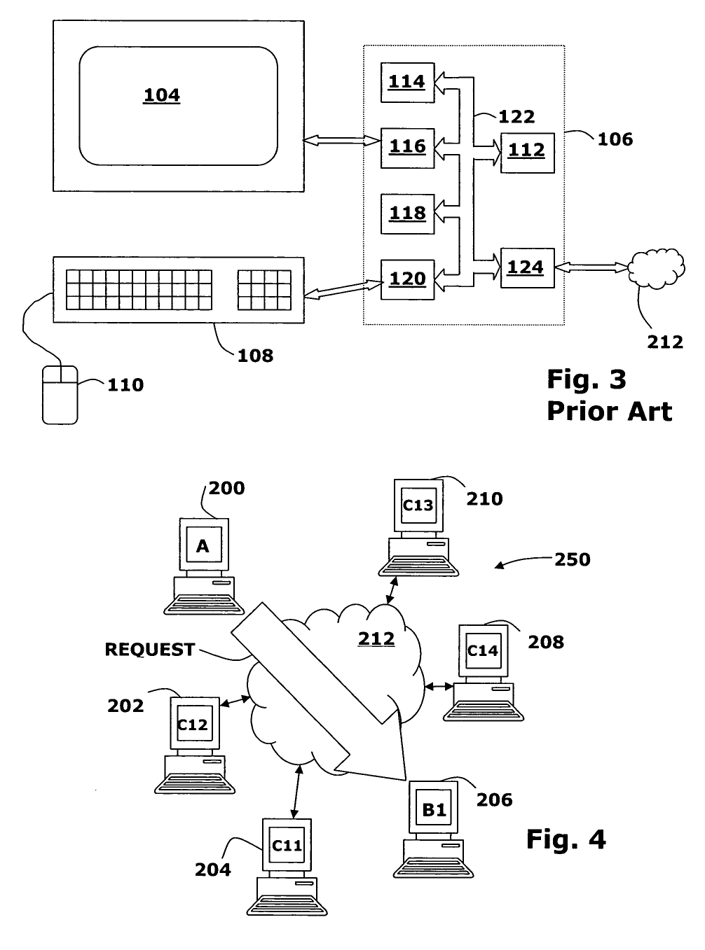

FIG. 3 shows the architecture of a prior art computing device which could be utilised under the present invention;

FIGS. 4 to 8 show steps in method of one embodiment of the present invention; and

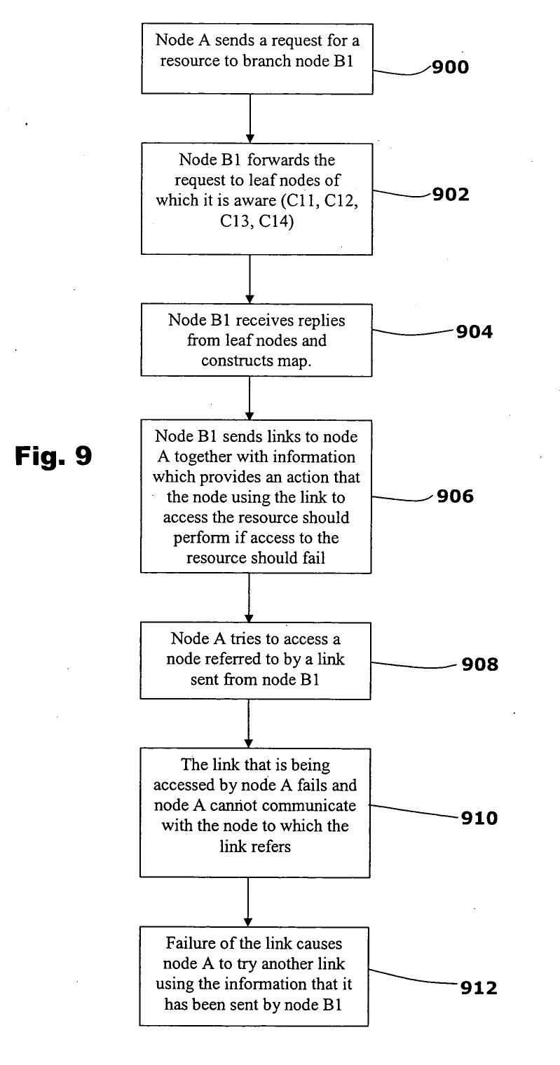

FIG. 9 shows a flow chart outlining the method represented in FIGS. 4 to 8.

FIG. 1 shows an illustration of how a query can propagate through a Peer-to-Peer network which may be used to share files (but which could be used to share other resources) and which is known in the prior art. A query originates from a first node A and is transmitted to nodes B1, B2, B3 (which may be referred to as branch nodes) of which the first node A has knowledge (i.e. the first node A can send data to the branch nodes). If the branch nodes B1, B2, B3 hold files which match the query, they will send a Hypertext Transfer Protocol (HTTP) link back to the first node A giving their own location and the location of the file that matches the request. The branch nodes B1, B2, B3 may also make a request for the same file from leaf nodes C11, C12, C13, C14, C21, C22, C23, C31, C32, C33 of which the branch nodes B1, B2, B3 have knowledge. If any of the leaf nodes C11 to C33 hold files which match the query, that leaf node C11 to C33 will send an HTTP link back to the first node A. This will be sent via the branch node B1, B2, B3 that routed the request giving their own location and the location of the file that matches the request. It will be appreciated that the first node A may or may not be aware of the leaf nodes C11 to C33.

Therefore, giving a specific example in relation to FIG. 1, the first node A sends a request for file X to branch nodes B1, B2, B3. These branch nodes B1 to B3 sends this request for file X to the leaf nodes C11 to C33. Node C14 has the file X and therefore transmits to branch node B1 indicating that it has file X. Branch node B1 then communicates the address of node C14 to the first node. The first node A can thereafter directly connect to the leaf node C14 and obtain file X. In some embodiments the transmission from leaf node C14 to the branch node B may contain the address of the node C14 and the branch node B1 may simply forward this to the first node B.

FIG. 2 shows the components of a simple Peer-to-Peer network, comprising a first, second, third, fourth, fifth and sixth node computing devices (labelled 200, 202, 204, 206, 208, 210 respectively) connected to a network 212 which in this case is the Internet. The skilled person will understand that computing devices 200-210 act as node computing devices because they are running a Peer-to-Peer software application (which may also be termed a software agent, or a program) allowing them to communicate and share resources with one another. The resources may be files or other data, storage space, spare processing cycles and the like.

It will be appreciated that, in this embodiment, because the network is the Internet the computing devices 200 to 210 may in fact be in different countries, or within the same room, or any distance in between. Tying FIG. 2 to the structure of FIG. 1, then the computing device 200 may be the first node A and it may only be aware of the address of the computing device 206, which may be the branch node B1 of FIG. 1. The remaining computing devices 204, 202, 210 and 208 may provide the leaf nodes C11, C12, C13 and C14 respectively.

Any suitable computing device may provide one of the nodes. Historically such computing devices have been computer such as PC's, Apples™, Workstations and the like. However, the number of computing devices that is capable of accessing a network and interacting with other computing devices is increasing and presently includes telephones (including mobile), PDA's, watches, televisions, notebook computers, computers and the like. Embodiments of this invention could be realised by any computing device capable of running the necessary program and connecting to other computing devices.

It will be appreciated that some peer-to-peer networks use a central server and the embodiments discussed herein may be applicable thereto, although these are not discussed in any detail. For the avoidance of doubt, such networks have included systems such as Napster, and the like. Further, it will be appreciated that many peer-to-peer networks operate over the Internet and as such rely on Domain Name Service (DNS) servers to resolve IP addresses. Although such DNS servers are not shown in the Figures, the skilled person will appreciate how these servers are utilised and will not be described fully although reference may be made later. However, aspects of the embodiments described herein may be applicable to other types of peer-to-peer networks and may comprise pico nets (ad hoc collections of node computing devices) and the like which may not comprise DNS servers.

In many peer-to-peer networks, for example that shown in FIG. 1 and 2, each of the nodes (for example a first node) may know the address of a number of other nodes. Through use of the Internet and associated DNS servers, nodes will be able to communicate with the nodes of which they are aware generally using a software agent on the node. The software agent may be a web browser, an ftp client, a plug into an existing software agent, or any other similar piece of software.

Further, as described in relation to FIGS. 1 and 2 each of the nodes of which the first node is aware may themselves be aware of more nodes and as such could forward communications from the first node to further nodes of which the first node was not aware. Thus, communications can be spread from a first node to a large number of other nodes in a small number of repeat transmissions often referred to as hops. Many peer-to-peer networks set a maximum limit on the number of hops over which a communication in the network can be sent. Such a limit on the number of hops may be used to reduce network latency and network traffic to acceptable levels.

FIG. 3 shows typical components of a computing device 106 that may provide a node of a peer-to-peer network. A mass storage device in the form of a hard drive 114, a display driver 116, a memory 118, an I/O port 120 and a transceiver 124 connect to a processing means 112 through a system bus 122. The display driver 116 drives a display 104. The I/O port 120 allows inputs to be received from a keyboard 108 and a mouse 110. The transceiver 124 allows the computing device 106 to connect to and receive information from a network 212.

Turning to an embodiment of the invention a user of the first node A within a peer-to-peer network 250 may send a request to one of the branch nodes B1, B2, B3 of which he/she is aware for a particular resource (which may be thought of as a remote resource to the first node A). This is as represented in FIG. 4 and at 900 in FIG. 9 in which the first node A (computing device 200) sends a request to computing device 206 which in this example is the first branch node B1. Of course, the first node A may send a request to a plurality of branch nodes (as shown in FIG. 1) and what is described hereinafter may occur in parallel for each of the branch nodes to which a request is sent.

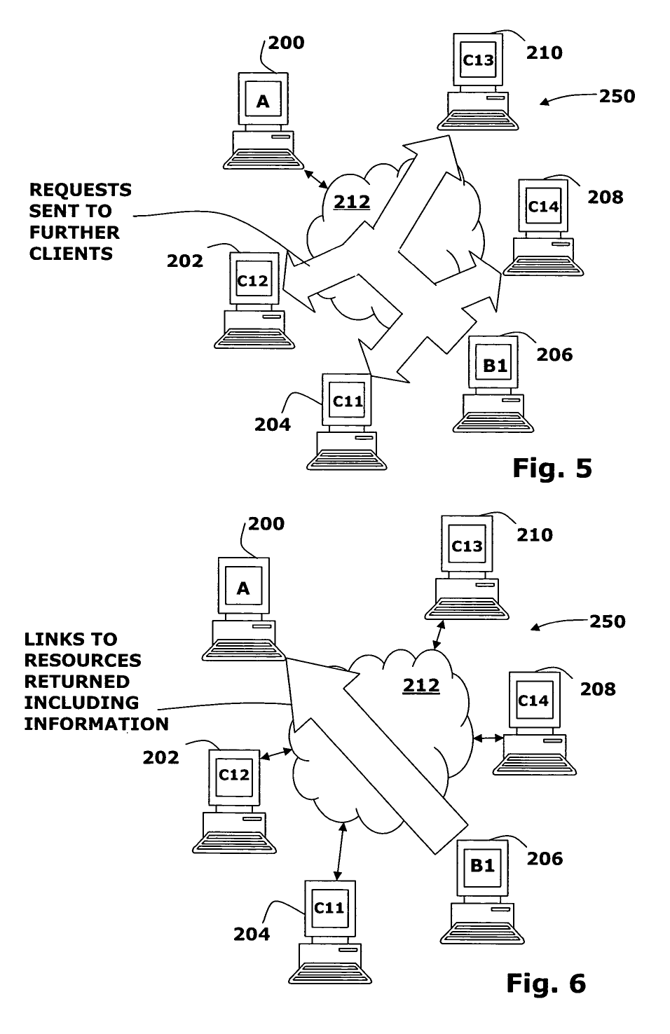

The first branch node B1 to which the requests was sent may respond with a link to the requested resource, acutable to connect the first node A to the resource, if it has it and/or the first branch node B1 may forward 902 that request on to other nodes—leaf nodes C11 to C14 in the example given. Forwarding of the request for the resource is shown in FIG. 5. The leaf nodes C11 to C14 respond if they have the requested resource.

The skilled person will readily understand the term link, but for the avoidance of doubt, a link provides a network address for a node of the network. Any of the nodes of the network can access another node of that network if the network address provided by the link is used. The underlying transport mechanisms of the network provide the mechanics of how to use the address to access a node. One such mechanism is the Hyper Text Transfer Protocol (HTTP) that provides the mechanics of the World Wide Web which runs over the Internet. In its broadest sense a link provides a mechanism for allowing a first node of a network to communicate with a second node of the network. Being able to access a node via a link may also allow a node (the first node) to access a resource on the node (the second node) to which the link refers.

The leaf nodes may in turn forward the request to other nodes, which may in turn forward, the request, etc. however, for reasons of clarity on two levels of nodes have been shown. In such embodiments in which the request is forwarded further, then any responses to the request will generally be routed back along the path that the request followed to reach the node with the resource.

Branch node B1 is able to construct what may be thought of as a map 904 of where the requested resource is located. Once a predetermined occurrence happens then the branch node B1 sends a response back to the first node A. The predetermined occurrence may be the elapse of a predetermined time, the location of a predetermined number of occurrences of the requested resource, etc.

In view of the map that the branch node B1 has created it may be able to send links, each actuable to connect the first node A to the resource that is being sought by the first node A. It is likely that if a plurality of different resource matching the request have been located that the links will be to a plurality of different computing devices within the network 250 and as such each link may be to an alternative resource within the network 250. However, in embodiments of the invention each of the links that the branch node B1 sends to the first node A has information added thereto, or otherwise associated therewith, that may alter how the link functions as will be described hereinafter. As represented in FIG. 6 and at 906 in FIG. 9 this information is returned to the first node A from the first branch node B1. The information may be added to a link, perhaps in a field after the link, as a file a file associated with the link, or by any other suitable means.

The skilled person will appreciate that the transceiver 124 receives the links and information from the Internet 212 and passes these, via the system bus 122 to various other components of the computing device 106 which may include the memory 118, the hard drive 114 and the processing means 112. The processing means 112 may be arranged to monitor the transceiver 124 in order to determine whether an attempted access of the remote resource has failed.

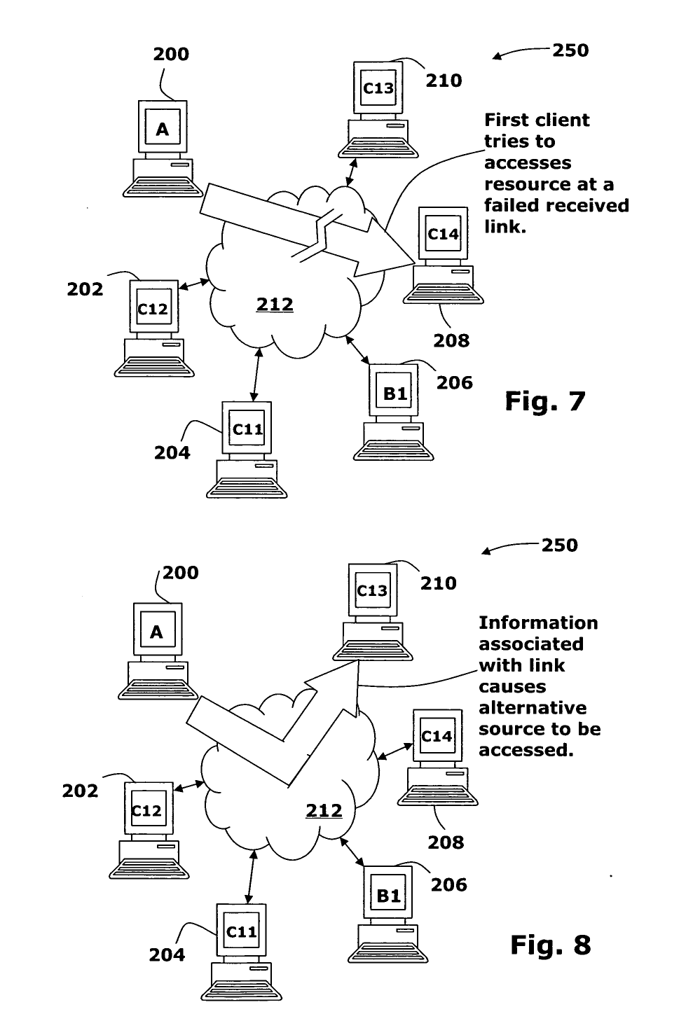

The first node A may attempt to access the resource by trying a first of the links that it has been sent from the branch node B1 and this is represented in FIG. 7 and at 908 in FIG. 9. However, the links to the resources provided to the first node A may fail 910 and the first node A may not therefore be able to access the desired resource. Such failure of the link may be for reasons such as the computing device (in this example 208 ) on which the resource is located is experiencing a large volume of network requests (it is known for sources within a peer-to-peer network 250 to become known, by nodes of the network, as a good source of resources and therefore experience a large number of requests); failure of a network connection to the source; failure of a portion of the network; or other similar scenarios. Such failure may result in slow performance in which data passes more slowly than usual between the first node A and other node C14 or absolute failure in which no data passes between the first node A and the other node C14. The first node A may compare performance of a connection to the resource provided by a link to a performance measure. If performance of the access is below a predetermined performance measure (i.e. below a predetermined threshold) then the link may be deemed to have failed.

The first link that the first node A tries may the first link that it receives; one or more nodes of the network may attach a ranking to the link such that the first node A may first try the link with the highest ranking it that it receives; it may be a random, pseudo random, or the like, selection of the link; or any other suitable mechanism for selecting a link.

The information associated with the links sent back to the first node A has an advantage that it passes management of failure, for example poor performance, of the link onto the first A and further nodes B1, B2, B3 rather than onto the infrastructure providing the underlying communication between the nodes (for example servers providing the Internet connections, the http and the like). The information may be thought of as increasing the tolerance of the peer-to-peer network of the link.

The information provided associated with the link may include any of the following: a list of one or more alternative links to other nodes; time delays associated with a link; a priority associated with that link, a mechanism to redirect the link according to a probability (as described later), a data rate associated with the link, or any other suitable non-functional information.

The skilled person will appreciate that such functionality may be implemented in a plurality of different ways and only some of these can be described herein. However, examples of possible arrangements include modification of the software agent; provision of a “plug in” for the software agent; modification of a web page which provides the links to other nodes.

In an embodiment with no server managing the links between nodes the links maintained by each node may have associated therewith the information to manage failure of the link, perhaps providing an alternative source of the resource. It is this information that can be sent to the first node when the node responds to a request from the first node.

When the first node A tries to access one of the links that it has been provided with the software agent being run by the first node A may monitor the performance of a request made by the first node A and applies the information associated with the link; generally a set of rules.

If the list of links known by a node to a resource is updated (perhaps further nodes return links to the resource, etc) then the information associated with the links may also be updated. Updating of the information is advantageous because it helps to maintain the peer-to-peer network's tolerance to failure of the links to resources. It will be appreciated that a node within a peer-to-peer network generally maintains a list, database, record, etc. of resources of which it is aware and that this list, etc. generally grows as the node becomes aware of more resources.

The information associated with a particular link may take the form of list of rules, each providing an alternative action, which generally will be tried in order, for example:

| | |
|---|---|
| 1 xyz.com/form=30=>xyz-fail/form | move over if not returned in |
| | 30 seconds |
| 2 xyz.com=On p=>xyz-fail.com | if the problem returns true |
| | then all xyz.com links |
| | changed to xyz-fail.com |
| 3 xyz-fail/form=120=>xyz-emergency/form | if the server fails |

These rules may be applied one after another until the failure of a link is overcome, or alleviated. In the first rule of the above examples a time out of thirty seconds is applied to the link. I.e. if the request from the first node A to another node is not replied to within thirty seconds the action associated with the rule is performed. In this example xyz.com is redirected to xyz-fail/form.

Should redirection to xyz-fail/form also fail then a redirect may be applied to all links to that predetermined address. In the example given all links including the address xyz.com are redirected to xyz-fail.com.

The next rule, rule 3, is reached if rule 2 also fails to work. In this rule it is assumed that a server involved in routing to the desired address has failed and a further redirect is performed and in the example rule a redirection to xyz-emergency/form occurs. Applying these example rules in order to a link may allow the behaviour of the software agent to be modified. The exact rules used will be implementation dependent and may include, but not be limited to, any of the following: timeout, retry count, absolute time, probabilistic reset.

The URL's used in the above examples are used purely by way of example and are not intended to have any specific reference.

Therefore, returning to the example embodiment shown in the Figures, the first node's A attempt to access the requested resource on leaf node C14 fails due to failure of the link (i.e. node A cannot communicate with the node who's address is given by the link). The information of the associated with the link that is has been sent causes the software agent running on the first node A to time the link out, and try a second link. This second link causes the first node A to access computing device 210, which provides leaf node C13. This is shown in FIG. 8 and at 912 in FIG. 9.

The rules discussed above may be modified in further embodiments. For example, rather than specifying links as an absolute re-direction (for example redirecting xyz.net/form to xyz.com/form) a probabilistic re-direction may be specified. For example, xyz.net/form may be redirected to xyz.com/form with a 90% probability and to xyz.com/form2 with a 10% probability. In order to determine to achieve this probabilistic redirection the software agent may determine a random number and use the outcome of that determination to decide the re-direction. For instance in the above example (assuming the random number is 0 to 9) then if the number is 0 to 8 redirection to xyz.com/form occurs and if the number is a 9 then redirection to xyz.com/form2 occurs.

A possible advantage of such probabilistic redirection is that it may provide load balancing to try and prevent the node receiving the redirected query from becoming over loaded. It will be appreciated that if a node is experiencing a demand greater than its capacity to handle links to that node may fail. If all of these failing links are re-directed to the same other node then that node may also not be able to cope. Therefore, probabilistic redirection may be advantageous to try and distribute the redirections so to reduce the chances of overloading the node to which redirection occurs.

It will be appreciated that a node within a peer-to-peer network may effectively establish a reputation amongst the users of other nodes in the network as being a good source of resources. As such, more and more users may request data from that node and that node may not be able to cope with the amount of requests that it is experiencing; it becomes a victim of its own success. The provision of information as to how the links may be redirected in such circumstances may allow the nodes requesting resources from that site to obtain a resource from another node. It will be appreciated that any one resource within a peer-to-peer network may be found on a plurality of different nodes. Preferably, the information allows a link to be re-routed without any intervention of a user of the nodes involved.

In other embodiments a server may be provided within a peer-to-peer network as is well known in the art. In such embodiments a node may log onto the server and download information therefrom. Conveniently, the information takes the form of a web page, which may contain a plurality of links to other nodes within the peer-to-peer network. In an embodiment of this invention the links on the server are provided with the information discussed above and which outlines how a software agent running on the node may handle poor performance of the link. Indeed, the computing devices in any of the Figures may be servers or clients when considered in the client/server architecture.

Further, it will be appreciated that one of the attractions of a peer-to-peer network is that although a first node has access to a set of other nodes, each of those other nodes may themselves have access to a further set of nodes.. Although there may be some overlap in the set of nodes of which the first node is aware and the further sets, these further sets are likely to contain nodes of which the first node has no knowledge. Therefore, the first node may access resources on nodes of which it has no initial knowledge by having its search/request for resources forwarded by nodes of which it is aware to other nodes of which it is not aware.

Any of the nodes, including the first node, in the network may be provided with information on how to redirect a poor performing link. Such an arrangement may be helpful in helping to introduce fault tolerance into the peer-to-peer network.

A software agent running on the node and/or a server in the peer-to-peer network may be arranged to up date the information associated with a link if it appears that such updating is necessary. The software agent that updates the information may or may not be the same as the software agent that allows communication with other nodes in the network.

In some embodiments, the software agent may monitor the number of times that a link fails and if this exceeds a predetermined criterion the software agent may request updated information from network, a server on the network, etc. The predetermined criteria may be a predetermined number, a predetermined number within a predetermined time, or the like.

In alternative, or additional embodiments, a software agent running on a server within the peer-to-peer network may detect the information needs updating and push the updated information onto a node.

1. A method of providing a node of a peer-to-peer network with access to a resource located within the network comprising providing the node with at least one link to the resource which is actuable to connect the node to the resource and the link having associated therewith information which provides an action that the node using the link to access the resource should perform if access to the resource should fail.

2. A method according to claim 1 in which the information provides at least one link to an alternative resource which is actuable to connect the node to that alternative resource.

3. A method according to claim 1 or 2 in which the information associated with the at least one link determines what defines failure of the attempted access to the resource.

4. A method according to claim 3 in which failure of the attempted access has at least one of the following definitions: failure to access the resource within a predetermined time; access to the resource has a lower performance than a predetermined performance measure.

5. A method according to claim 4 in which the predetermined performance measure comprises a data transfer rate of the resource to the node below a predetermined threshold.

6. A method according to any preceding claim in which the resource comprises at least one of the following: a file; a program, processor cycles of a processor; storage capacity.

7. A method according to any preceding claim in which the information provides a plurality of alternative actions that the node should perform should access fail.

8. A method according to claim 7 in which the alternative actions are performed one at a time to try and achieve access to the resource.

9. A method according to any preceding claim in which the information associated with a link provides load balancing of communications across the network.

10. A method according to claim 10 in which the information associated with a link causes random or pseudo random connection to an alternative resource should access to access to the resource fail.

11. A node of a peer-to-peer network comprising a transceiver and a processing means, said transceiver being arranged to connect to the network and receive at least one link to a remote resource which is actuable to connect the node to the remote resource, the link having information associated therewith said transceiver being arranged to pass said link and information to said processing means, said processing means being arranged to attempt to access a resource provided by said link using said transceiver and further arranged to monitor said transceiver during the attempted access, and the processing means being further arranged to carry out an action provided by the information should the monitoring of the transceiver determine that access to the resource has failed.

12. A node according to claim 11 that is arranged to determine that access to the resource has failed if access does not occur within a predetermined time.

13. A node according to claim 12 that is arranged to determine that access to the resource has failed if the access has a lower performance than a predetermined performance measure.

14. A peer-to-peer network comprising a plurality of nodes each capable of communicating with one another, said nodes being arranged to provide to one another links to resources within the network actuable to connect a node to at least one of the resources the resource, said nodes being further arranged to associate with such links information which provides an action that the node using the link should perform if access to the resource should fail.

15. A network according to claim 14 in which the resource comprises at least on of the following: a file, a program, processor cycles of a processor, storage capacity.

16. A network according to claim 14 or 15 in which one or more nodes are arranged to send information associated with a link that provides a plurality of alternative actions should access to a resource fail.

17. A network according to claim 16 in which one or more nodes are arranged to send information associated with a link that causes the node receiving the information to access an alternative resource should access to a resource fail.

18. A network according to any of claims 14 to 17 in which the information associated with a link is arranged to provide load balancing of the communications across the network.

19. A software agent for a node of a peer-to-peer network, the software agent being arranged to process information associated with a link, provided to the node, which is actuable to connect the node to a resource and the software agent being arranged to cause the node to perform an action should the link fail to provide access the resource.

20. A software agent according to claim 19 which is at least one of te following: a plug-in to an existing software agent; a script; an additional program.

21. A computer program which allows a node of a peer-to-peer network to receive at least one link actuable to connect the node to a remote resource on at least one other node of the network, the link having information associated therewith, the program allowing the node to attempt to access the remote resource provided by the link, and monitor progress of the attempted access, the program being further arranged to carry out an action provided by the information should monitoring of the attempted access determine that the access has failed.

22. A machine readable medium containing instructions which when read by a computing device cause that computing device to perform the method of any of claims 1 to 10.

23. A machine readable medium containing instructions which when read on to at least one node of a peer-to-peer network cause the network to function as the network of any of claims 14 to 18.

24. A machine readable medium containing instructions which when read on to a node of a peer-to-peer network cause that node to function according to any of claims 11 to 13.

25. A machine readable medium containing instructions which when read on to a computer cause that the software agent of claims 19 or 20 to be loaded onto the computer.

26. A machine readable medium containing instructions which when read on to a computer cause the computer program of claim 21 to be read onto the computer.

27. A method of providing a node of a peer-to-peer network with access to a resource substantially as described and as illustrated herein with reference to FIGS. 4 to 8 of the accompanying drawings.

28. A node of a peer-to-peer network substantially as described and as illustrated herein with reference to FIGS. 4 to 8 of the accompanying drawings.

29. A peer-to-peer network substantially as described and as illustrated herein with reference to FIGS. 4 to 8 of the accompanying drawings.

30. A software agent substantially as described and as illustrated herein with reference to FIGS. 4 to 8 of the accompanying drawings.

31. A computer program substantially as described and as illustrated herein with reference to FIGS. 4 to 8 of the accompanying drawings.
